(19) United States
(12) Patent Application Publication
(10) Pub. No.: US 2025/0024050 A1
(43) Pub. Date: Jan. 16, 2025

(54) Encoding and Decoding for Multi-Format Bitstream

(71) Applicant: Nokia Technologies Oy, Espoo (FI)

(72) Inventors: Lukasz KONDRAD, Munich (DE); Emre Baris AKSU, Tampere (FI); Patrice RONDAO ALFACE, Antwerp (BE); Miska Matias HANNUKSELA, Tampere (FI); Lauri Aleksi ILOLA, Tampere (FI); Kashyap KAMMACHI SREEDHAR, Tampere (FI)

(21) Appl. No.: 18/349,765

(22) Filed: Jul. 10, 2023

(51) Int. Cl. H04N 19/169; H04N 19/184

(52) U.S. Cl. CPC H04N 19/188; H04N 19/184

(57) ABSTRACT

Two or more bitstreams of a content representation are obtained. A first bitstream is encoded according to a first format and a second bitstream is encoded according to a second format. The two or more bitstreams are merged into a multi-format bitstream. First signaling indicates there are data of the first format and of the second format, and second signaling indicates mapping of NAL units between the first and second formats in the multi-format bitstream. A decoder receives a multi-format bitstream and first signaling therein indicating there are data of a first format and of a second format in the multi-format bitstream Second signaling is received indicating mapping of NAL units between the first and second formats. Data are separated, from the multi-format bitstream using the first signaling and the second signaling, the data having the first format and related data having the second format. The data is decoded.

### TECHNICAL FIELD

Examples of embodiments herein relate generally to video encoding and decoding and, more specifically, relate to video encoding and decoding for a multi-format bitstream.

### BACKGROUND

For video encoding and decoding, the encoder forms a bitstream that is sent to the decoder for decoding, e.g., and typically presentation to a user. That bitstream can contain multiple formats and be referred to as a multi-format bitstream. For instance, representation of a compressed point cloud may consist of multiple different encoded component bitstreams, of different format, that together reconstruct the point cloud. To the extent that these different formats are combined into one bitstream, this bitstream would be a multi-format bitstream.

### BRIEF SUMMARY

This section is intended to include examples and is not intended to be limiting.

In an exemplary embodiment, a method is disclosed that includes obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

An exemplary computer program product includes a computer-readable storage medium bearing instructions that, when executed by an apparatus, cause the apparatus to perform at least the following: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

In another exemplary embodiment, an apparatus comprises means for performing: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

In an exemplary embodiment, a method is disclosed that includes receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

An exemplary computer program product includes a computer-readable storage medium bearing instructions that, when executed by an apparatus, cause the apparatus to perform at least the following: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

In another exemplary embodiment, an apparatus comprises means for performing: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

### BRIEF DESCRIPTION OF THE DRAWINGS

In the attached drawings:

FIG. 1 is a block diagram of one possible and non-limiting exemplary system in which the exemplary embodiments may be practiced;

FIG. 2 illustrates an example V3C bitstream and possible V3C units the bitstream may contain;

FIG. 3 presents an overview of parameter sets mapping to NAL units (where each square block represents an NAL unit);

FIG. 4 presents an overview of coded sequence and access units mapping to NAL units (where each square block represents an NAL unit);

FIG. 5 is a table (Table 1) having an example layer-to-data type mapping;

FIG. 5A is an illustration and flowchart using the table of FIG. 5 and other information to illustrate first and second signaling used in a multi-format bitstream;

FIG. 6, which is split over FIGS. 6A and 6B, is an example of a relation between the different syntax structures in an atlas bitstream indicated by IDs;

FIG. 7 illustrates an example of relation of NAL units in an atlas bitstream;

FIG. 8 illustrates an example of consecutive NAL units of different layers composing an access unit in atlas bitstream;

FIG. 9 is an example of a block diagram of an apparatus suitable for implementing any of the encoders or decoders described herein;

FIG. 10 shows a block diagram of a general structure of a video encoder for two layers;

FIG. 11, split over FIGS. 11A and 11B, illustrates a method for encoding; and

FIG. 12 illustrates a method for decoding.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that capital and lowercase acronyms are considered to be the same. For instance, vdmc and VDMC are considered to be the same.

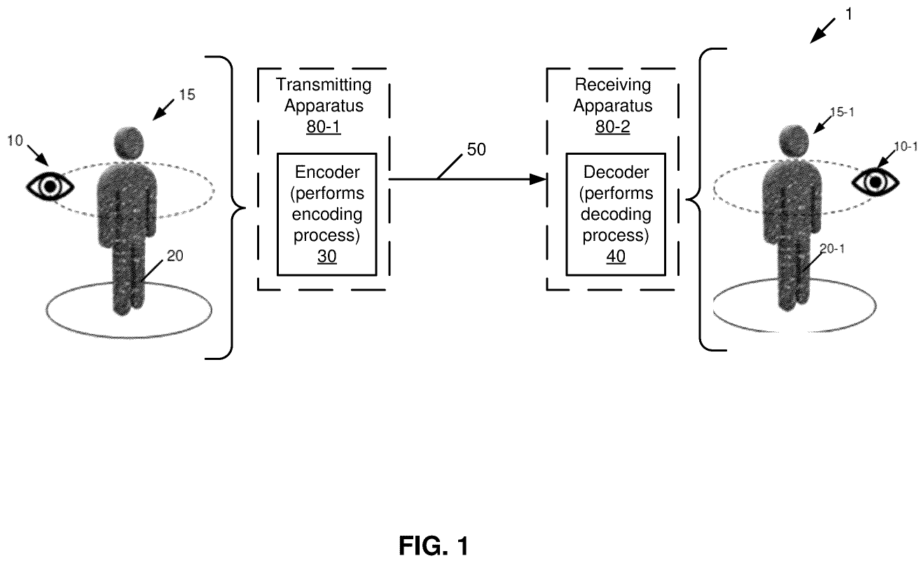

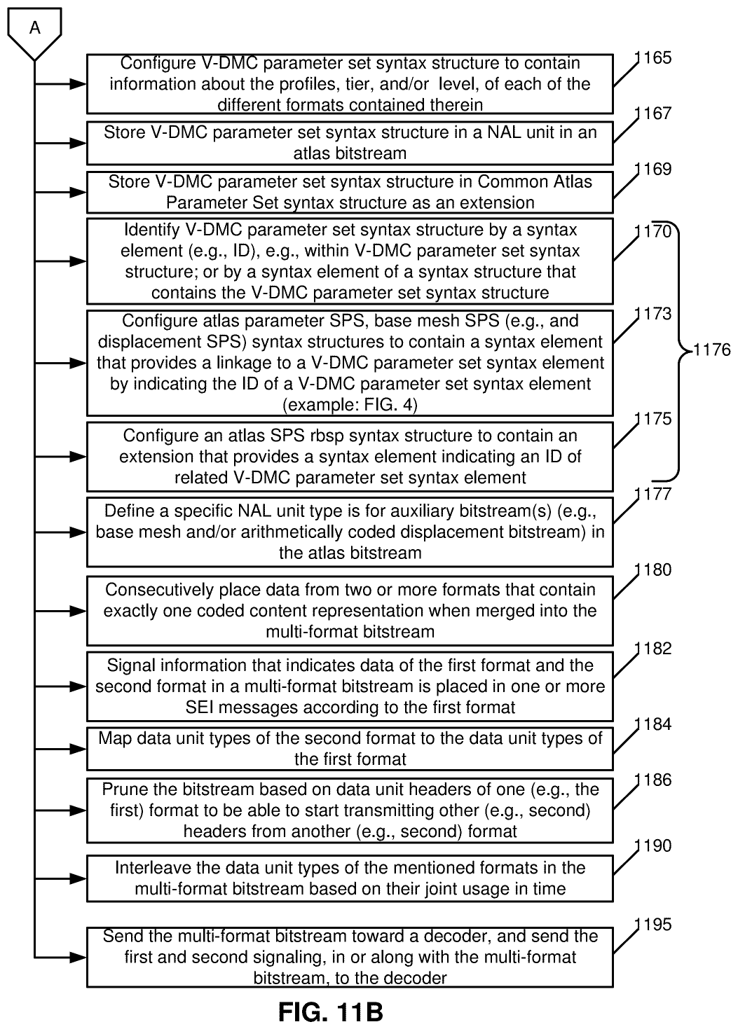

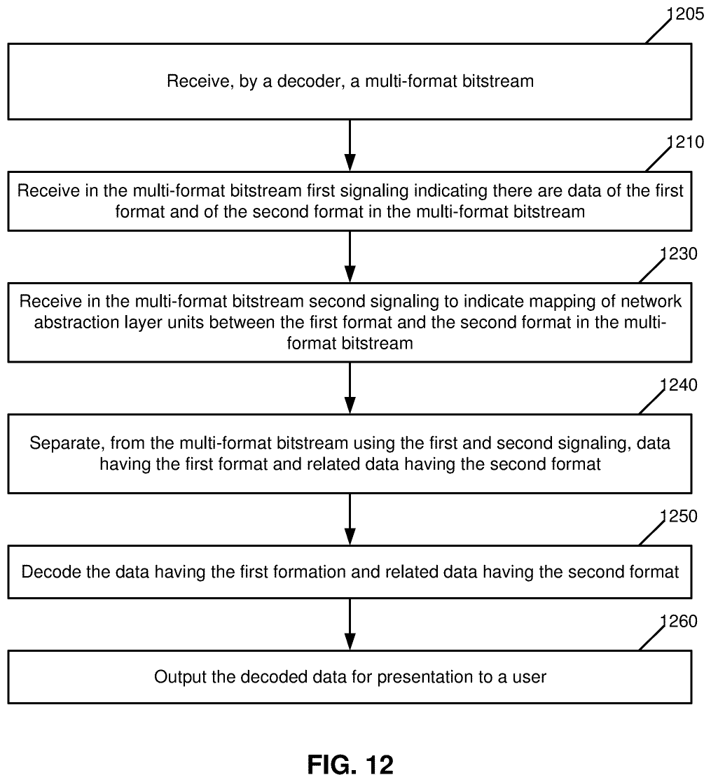

Any flow diagram (such as FIG. 11 or 12) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1, 9, and 10) may also illustrate the operation of an exemplary method, results of execution of computer program instructions embodied on a computer readable memory, functions performed by logic implemented in hardware, and/or interconnected means for performing functions in accordance with an exemplary embodiment.

Referring to FIG. 1, this figure is a block diagram of one possible and non-limiting exemplary system 1 in which the exemplary embodiments may be practiced. This figure provides a simple overview of what transmission of video from one location to another might entail. In this example, there is a capture of three-dimensional (3D) media using, e.g., a volumetric video capture based on a viewpoint 10 of a scene 15, which includes a human being 20. In the example, the encoder 30 is used to encode video from the scene 15, and the encoder 30 is implemented in a transmitting apparatus 80-1. The encoder 30 performs an encoding process and produces a bitstream 50, e.g., a multi-format bitstream, that is received by the receiving apparatus 80-2, which implements a decoder 40. The receiving apparatus 80-2 reproduces a version of the 3D media at a viewpoint 10-1 of a scene 15-1, which includes a human being 20-1.

The decoder 40 performs a decoding process and forms the video for the scene 15-1, and the receiving apparatus 80-2 could output information suitable for presentation or could present this to the user (not shown), e.g., via a smartphone, television, head-mounted display, or projector among many other options.

Now that an example of a system is described, an overview of the technological area is provided. After the overview, problems are described, then examples of embodiments are presented.

The examples described herein relate at least in part to volumetric video. As is known, the term volumetric video refers to a technique used in video coding and decoding that aims to capture and reproduce 3D representations of real-world objects or scenes. It goes beyond traditional two-dimensional (2D) video by capturing data about the shape, appearance, and movement of objects from multiple viewpoints, enabling viewers to experience a scene from different angles and perspectives. For example, the viewpoints 10 and 10-1 shown in FIG. 1 can be modified and moved. Once the volumetric data is captured, it needs to be compressed for efficient storage and transmission. Various compression techniques, such as point cloud compression or mesh-based representations, can be applied to reduce the size of the data while preserving its visual quality. On the decoding side, the compressed volumetric data is received and processed to reconstruct the 3D representation (e.g., 15-1) of the scene.

There are many ways to capture and represent a volumetric frame. The format used to capture and represent this video depends on the processing to be performed on the video, and the target application using the video. Some exemplary representations are listed below.

1) A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA value, or normal vectors). As is known, RGBA refers to a color space that has reg (R), green (G), and blue (B) channels and also includes an extra channel (alpha channel) for representing the transparency information of an image.

2) A volumetric frame can be represented as images, with or without depth, captured from multiple viewpoints in 3D space. In other words, it can be represented by one or more view frames (where a view is a projection of a volumetric scene onto a plane, the camera plane, using a real or virtual camera with known/computed extrinsics and intrinsics). Each view may be represented by a number of components (e.g., geometry, color, transparency, and occupancy picture), which may be part of the geometry picture or represented separately.

3) A volumetric frame can be represented as a mesh. A mesh is a collection of points, called vertices, and connectivity information between vertices, called edges. Vertices along with edges form faces. The combination of vertices, edges, and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and roll). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

Volumetric video contains a sequence of volumetric frames. As previously stated, due to the large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specifications such as ISO/IEC 23090-5. The coded images and the associated metadata can be stored or transmitted to a client that can decode and render the 3D volumetric frame.

Another topic concerning volumetric video is Visual Volumetric Video-based Coding (V3C)-ISO/IEC 23090-5. ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame. As is known, a V3C encoder converts volumetric frames, as 3D volumetric information, into a collection of 2D images and associated data, known as atlas data.

Two applications of V3C (via ISO/IEC 23090-5) have been defined, V-PCC (ISO/IEC 23090-5) and MIV (ISO/IEC 23090-12). MIV and V-PCC use a number of V3C syntax elements with a slightly modified semantics. An example on how the generic syntax element can be differently interpreted by the application is pdu_projection_id.

1) In case of V-PCC, the syntax element pdu_projection_id specifies the index of the projection plane for the patch. There can be 6 to 18 projection planes in V-PCC, and they are implicit, i.e., pre-determined.

2) In case of MIV, the syntax element pdu_projection_id corresponds to a view ID, i.e., identifies which view the patch originated from. View IDs and their related information are explicitly provided in MIV view parameters list and may be tailored for each content.

The MPEG 3DG (ISO SC29 WG7) group has started work on a third application of V3C—the mesh compression. It is also envisaged that mesh coding will reuse V3C syntax as much as possible and can also slightly modify the semantics.

To differentiate between applications of a V3C bitstream, which allow a client to properly interpret the decoded data, V3C uses the ptl_profile_toolset_idc parameter.

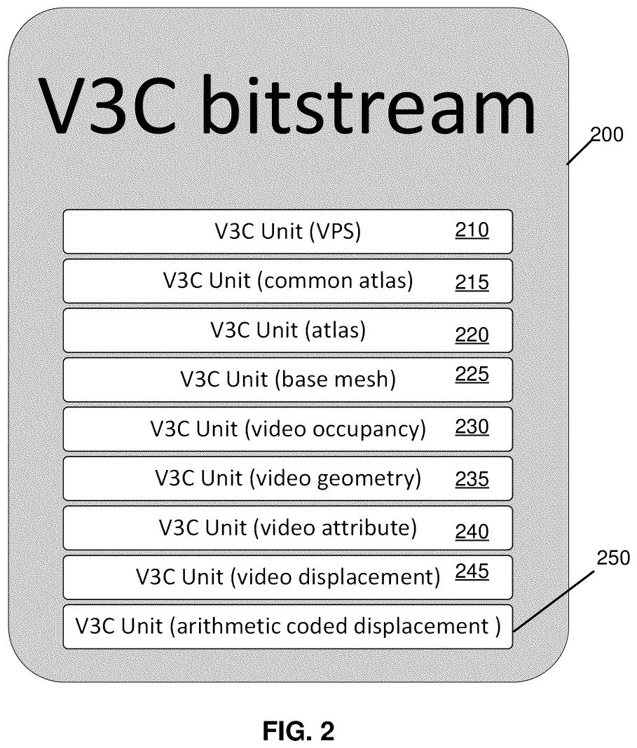

Another topic of interest for V3C is a V3C bitstream, e.g., as bitstream 50 of FIG. 1. A V3C bitstream is a sequence of bits that forms the representation of coded volumetric frames and the associated data making one or more coded V3C sequences (CVSs). See FIG. 2, which illustrates an example V3C bitstream 200 (e.g., as part or all of bitstream 50 of FIG. 1) and possible V3C units the bitstream may contain. In this example, the V3C bitstream 200 comprises one or more of the following V3C units: VPS 210; common atlas 215; atlas 220; base mesh 225; video occupancy 230; video geometry 235; video attribute 240; video displacement 245; and/or arithmetic coded displacement 250. As is known, a base mesh defines a coarse mesh, consisting of vertices and connectivity information (e.g., edges) between vertices, approximating the content in the volumetric frame. The base mesh can be subdivided, using various subdivision methods, into a more granular mesh representation, i.e., having a higher level of detail. Video displacement and arithmetic coded displacement information represent displacements of generated, as a result of subdivision, vertices in a higher level of detail mesh approximations.

CVS is a sequence of bits identified and separated by appropriate delimiters, and is required to start with a VPS, includes a V3C unit, and contains one or more V3C units with atlas sub-bitstream or video sub-bitstream. Video sub-bitstreams and atlas sub-bitstreams can be referred to as V3C sub-bitstreams. Which V3C sub-bitstream a V3C unit contains and how to interpret it is identified by a V3C unit header in conjunction with VPS information.

A V3C bitstream can be stored according to Annex C of ISO/IEC 23090-5, which specifies syntax and semantics of a sample stream format to be used by applications that deliver some or all of the V3C unit stream as an ordered stream of bytes or bits within which the locations of V3C unit boundaries need to be identifiable from patterns in the data.

A further topic of interest is Video-based Point Cloud Compression (V-PCC)—ISO/IEC 23090-5. The generic mechanism of V3C may be used by applications targeting volumetric content. One of such application is video-based point cloud compression (ISO/IEC 20390-5). V-PCC enables volumetric video coding for application in which a scene is represented by a point cloud. V-PCC uses a patch data unit concept from V3C and, for each patch, assigns one of 6 to 18 pre-defined orthogonal camera views for reprojection.

Another application of V3C is MPEG immersive video (ISO/IEC 23090-12). MIV enables volumetric video coding for applications in which a scene is recorded with multiple RGB (D) (red, green, blue, and optionally depth) cameras with overlapping fields of view (FoVs). One example setup is a linear array of cameras pointing towards a scene. This multi-scopic view of the scene allows a 3D reconstruction and therefore 6DoF/3DoF+ consumption.

MIV uses the patch data unit concept from V3C and extends this concept by using application-specific camera views for reprojection. This is in contrast to V-PCC, which uses pre-defined 6 to 18 orthogonal camera views for reprojection. Additionally, MIV introduces additional occupancy packing modes and other improvements to the V3C base syntax. One such example is support for multiple atlases, for example when there is too much information to pack everything in a single video frame. It also adds support for common atlas data, which contains information that is shared between all atlases. This is particularly useful for storing camera details of the input camera models, which are frequently shared between different atlases.

Video-based dynamic mesh coding (V-DMC) (see ISO/IEC 23090-29) is another application form of V3C that aims on integration of mesh compression into the V3C family of standards. The standard is under development and at a WD stage (MDS22775_WG07_N00611).

The retained technology after the CfP result analysis is based on multiresolution mesh analysis and coding. This approach includes the following:
1) generating a base mesh that is a simplified (low resolution) mesh approximation of the original mesh, called a base mesh (this is done for all frames of the dynamic mesh sequence);
2) performing several mesh subdivision iterative steps (e.g., each triangle is converted into four triangles by connecting the triangle edge midpoints on the generated base mesh), generating other approximation meshes;
3) defining displacement vectors, also named error vectors, for each vertex of each mesh approximation;
4) for each subdivision level, adding the displacement vectors to the subdivided mesh vertices generates the best approximation of the original mesh at that resolution, given the base mesh and prior subdivision levels;
5) the displacement vectors may undergo a lazy wavelet transform prior to compression; and
6) the attribute map of the original mesh is transferred to the deformed mesh at the highest resolution (i.e., subdivision level) such that texture coordinates are obtained for the deformed mesh and a new attribute map is generated.

The V-DMC generate compressed bitstreams which later on are packed in V3C units and create V3C bitstream by concatenating V3C units:
1) A sub-bitstream with the encoded base mesh using a mesh codec;
2) A sub-bitstream with the displacement vectors that is:
a) packed in an image and encoded using a video codec, or
b) arithmetic-encoded as defined in Annex J of WD ISO/IEC 23090, MDS22775_WG07_N00611.
3) A sub-bitstream with the attribute map encoded using a video codec;
4) A sub-bitstream (atlas) that contains all metadata required to decode and reconstruct the mesh sequence based on the aforementioned sub-bitstreams. The signaling of the metadata is based on the V3C syntax and includes necessary extensions that are specific to meshes.

Another topic for consideration is Low Complexity Enhancement Video Coding (LCEVC)-ISO/IEC 23094-2. LCEVC is a low complexity solution to apply enhancement to existing video coding bitstreams generated using other video coding systems, e.g., AVC. HEVC, VVC. An LCEVC bitstream carries an enhancement to a “base” codec bitstream. A lower resolution (and potentially also lower bit depth) version of a source video is encoded using any existing codec (the “base codec”) and then LCEVC is used for coding the differences between the lower resolution video and the full resolution source, up to mathematically lossless coding if needed, using a different compression method (the “enhancement”). LCEVC comprises specialized coding tools to correct impairments, upscale and add details to the processed video of the base codec.

Processing for the base encoder (e.g., the encoder 30 of FIG. 1) is as follows. Firstly, the input sequence is fed into two consecutive non-normative downscalers and is processed according to the chosen scaling modes. Any combination of the three available options (2-dimensional scaling. 1-dimensional scaling in the horizontal direction only or no scaling) can be used. The output then invokes the base codec, which produces a base bitstream according to its own specification.

Secondly, there is enhancement sub-layer 1 encoding. The reconstructed base picture may be upscaled to undo the downscaling process and is then subtracted from the first-order downscaled input sequence in order to generate the sub-layer 1 (L-1) residuals. These residuals form the starting point of the encoding process of the first enhancement sub-layer. A number of coding tools, which will be described further in the following, may be used to process the input and generate entropy encoded quantized transform coefficients.

Thirdly, there is enhancement sub-layer 2 encoding. As a last step of the encoding process, the enhancement data for sub-layer 2 (L-2) needs to be generated. In order to create the residuals, the coefficients from sub-layer 1 are processed by an in-loop LCEVC decoder to achieve the corresponding reconstructed picture. Depending on the chosen scaling mode, the reconstructed picture may be processed by an upscaler. Finally, the residuals are calculated by a subtraction of the input sequence and the upscaled reconstruction. Similar to sub-layer 1, the samples are processed by a few coding tools. In addition, a temporal prediction can be applied on the transform coefficients in order to achieve a better removal of redundant information. The entropy encoded quantized transform coefficients of sub-layer 2, as well as a temporal layer specifying the use of the temporal prediction on a block basis, are included in the LCEVC bitstream.

On the decoding side, the following are performed. Decoding for the base decoder is performed. In order to generate the Decoded Base Picture (Layer 0), the base decoder is fed with the base bitstream. According to the chosen scaling mode in the configuration, this reconstructed picture might be upscaled and is afterwards called a preliminary intermediate picture.

What follows is enhancement sub-layer 1 decoding. Following the base layer, the enhancement part needs to be decoded. Firstly, the coefficients belonging to enhancement sub-layer 1 are decoded using the inverse tools of the encoding process. Additionally, an L-1 filter might be applied in order to smooth the boundaries of a transform block. The output is then referred to as enhancement sub-layer 1 and is added to the preliminary intermediate picture which results in the combined intermediate picture. Again, depending on the scaling mode, an upscaler might be applied and the resulting preliminary output picture has then the same dimensions as the overall output picture.

Enhancement sub-layer 2 decoding is then performed. As a final step, the second enhancement sub-layer is decoded. According to the temporal layer, a temporal prediction might be applied to the dequantized transform coefficients. This enhancement sub-layer 2 is then added to the preliminary output picture to form the combined output picture as a final output of the decoding process.

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC. 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification, which includes AV2 bitstream format and decoding process.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

In some coding formats or standards, a bitstream may be in the form of a network abstraction layer (NAL) unit stream or a byte stream, that forms the representation of coded pictures and associated data forming one or more coded video sequences.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266/VVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata.

Now that an overview of the technological area has been provided, problems in the area are described. As part of a problem, the V3C specification defines V3C units that are used to store the common atlas, atlas, and video component bitstreams in a single V3C bitstream.

On a V3C bitstream level, there is no concept of access unit, i.e., a continued range of data in V3C bitstream that would contain units that are consecutive in decoding order and generate a single displayable output frame with a given presentation time. Instead, on the V3C bitstream level, there is a concept of a composition unit, i.e., non-continuous data within the V3C bitstream that have the same composition time. The composition unit is a theoretical concept whose timing is signaled by an application, for example by timing of samples in ISOBMFF.

A V-DMC application introduces new component bitstreams (V3C unit types) to V3C: base mesh bitstream (Annex H of WD ISO/IEC 23090, MDS22775_WG07_N00611) and arithmetic coded displacement bitstream (Annex H of WD ISO/IEC 23090, MDS22775_WG07_N00611) or visually coded displacement bitstream.

Some potential problems include the following:

1) The introduction of new component bitstreams further complicate the synchronization aspects on the application level and the proper creation of a composition unit. As used herein, a composition unit is a collection of NAL units (possibly from different substreams) that together compose a volumetric frame, e.g., having the same composition time. It is noted that a substream is a bitstream that makes up a multi-format bitstream.

2) The new bitstreams do not have an explicit connection to common atlas and atlas bitstreams (for example by explicit ID and timing information), while some semantics defined in WD ISO/IEC 23090, MDS22775_WG07_N00611 would require such clarity, e.g., semantics of asps_vmc_ext_subdivision_method indicates the identifier of the method to subdivide the meshes associated with the current atlas sequence parameter set. The association can be only signaled on the application level using timing information, as the base mesh and atlas are separate bitstreams and there is no direct association in the V3C bitstream. The application would need to have a direct linkage to the encoder to make such decisions.

3) The new bitstreams use the same NAL unit types but do not share the NAL unit space.

4) The application/system aspect are not yet defined for the new base mesh and displacement bitstreams, which will potentially slow down deployment of the standard.

5) The fundamental idea behind the V3C was to have atlas bitstream(s) (metadata) plus video bitstream(s). Introduction of new types of bitstreams (such as base mesh and arithmetically coded displacements) require changes to this structure.

Similar problems can be seen in LCEVC. There may be a need to consider and develop a technical solution to carry a complete set represented by a base bitstream and an LCEVC bitstream as a single bitstream and consequently a single track in terms of MPEG-2 TS PID or ISOBMFF track. One reason is that there are many commercial player implementations, particularly in the streaming space, where a player can only support a single stream playback. Moreover, the use of a single-track approach could simplify the design of players. Furthermore, some application programming interfaces (APIs) may support only a single video stream.

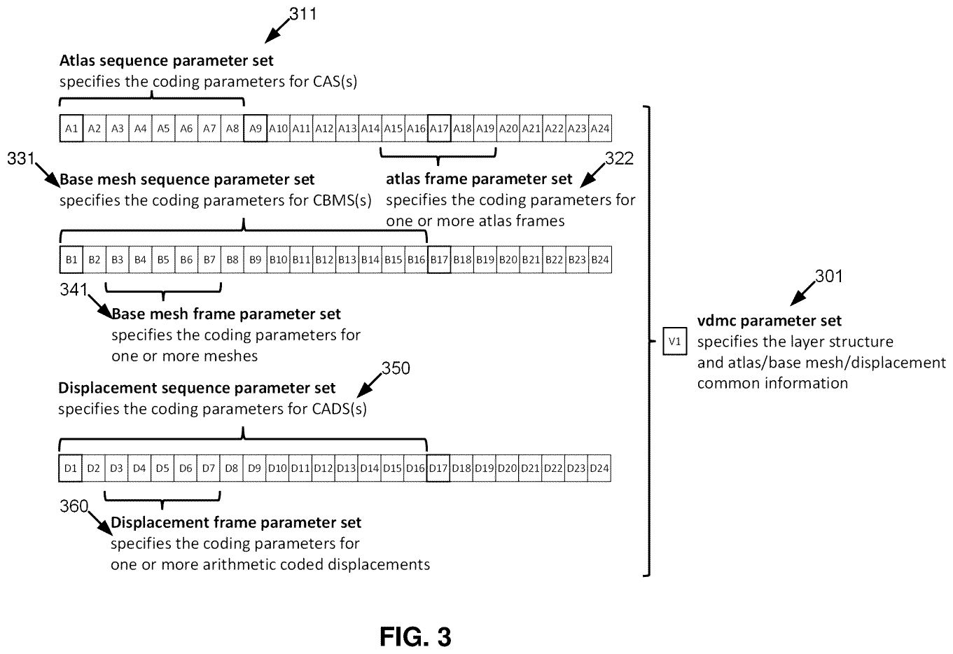

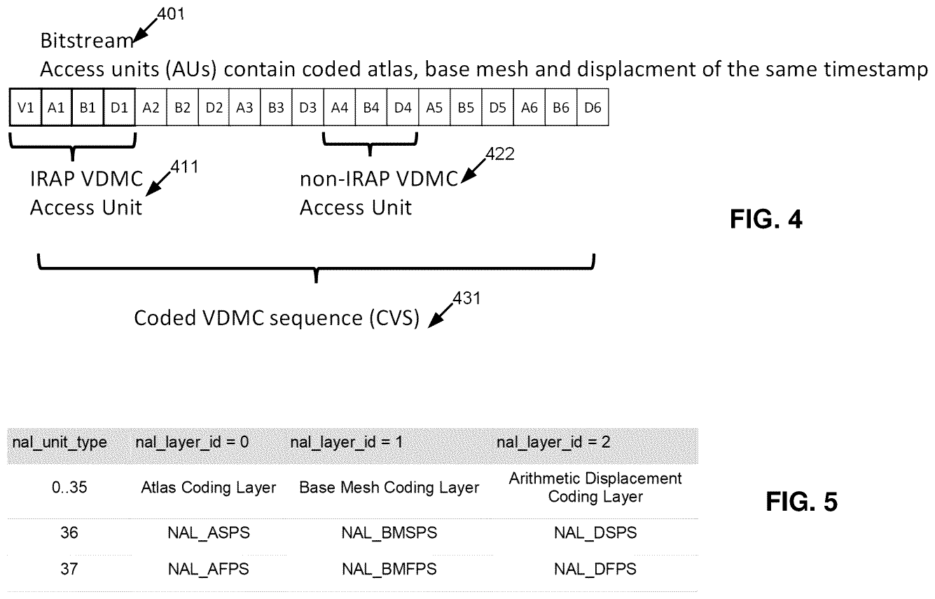

To address these issues, embodiments herein describe techniques for encoding, storing, and decoding video. In an example, a V-DMC encoder creates data, i.e., syntax elements, for common atlas, atlas, base mesh, and arithmetic displacement for each mesh frame. These syntax elements contain information that together with the way they are stored in consecutive NAL units allows a decoder to clearly identify an access unit (i.e., data belonging to a given time instance) and identify the relations between those syntax elements in different NAL units. In this document, methods are proposed describing how these syntax elements for one mesh frame can be stored as consecutive NAL units in a single atlas sub-bitstream (in V3C terminology, it is an atlas bitstream), which reduces the overall number of separate sub-bitstreams and simplifies the design for systems-level technologies like file formats and streaming protocols. A high-level overview is presented in FIGS. 3 and 4. Each square on the figures represents an NAL unit with different numbers identifying different NAL units (i.e., NAL unit header can have different type/layer/temporal id).

Turning to FIG. 3, this figure presents an overview of parameter sets mapping to NAL units (where each square block represents a sub-bitstream access unit, i.e., a collection of NAL units corresponding to the same time instance). There is a video-based dynamic mesh coding (vmdc) parameter set 301, which specifies the layer structure and atlas, base mesh, and/or displacement common information. The vmdc parameter set 301 comprises an atlas sequence parameter set 311, a base mesh sequence parameter set 331, and a displacement sequence parameter set 350. The atlas, base mesh, and displacement information are different formats and the vmdc parameter set 301 is a multi-format parameter set. That is, for VDMC, there are usually two formats: atlas and base-mesh. There are, however, options for arithmetically-coded displacements (and possibly more in the future), which may be implemented via the displacement sequence parameter set 350 (or additional parameter sets). It is noted that each of the sets 311, 331, and 350 can be considered to be a bitstream (also referred to as a substream) with at least its own format.

Each atlas sequence parameter set 311 specifies the coding parameters for a coded atlas sequence (CAS), e.g., atlas access units A1-A8, A9-16, and the like. The validity of atlas frame parameter set 322, which specifies the coding parameters for one or more atlas access units, is not limited to a coded atlas sequence. In the example, the validity can be set per frame e.g., from A15-A19 thus carrying over a coded atlas sequence boundary, A16-A17. As is known, the term “validity” indicates when a given parameter set should be used to decode video coding or atlas coding layer NAL units.

The base mesh sequence parameter set 331 specifies the coding parameters for a coded base mesh sequence (CBMS), e.g., base mesh access units B1-B16, B17-B32, and the like. The validity of base mesh frame parameter set 341, which specifies the coding parameters for one or more base mesh access units, is not limited to coded base mesh sequence. In the example, the validity can be set per frame e.g., from B3-B7.

The displacement sequence parameter set 350 specifies the coding parameters for coded arithmetic displacement sequence (CADS), e.g., arithmetic displacement access units D1-D16, D17-D32, and the like. The validity of arithmetic displacement frame parameter set 360, which specifies the coding parameters for one or more arithmetic displacement access units, is not limited to coded arithmetic displacement sequence. In the example the validity can be set per frame, e.g., from D3-D7.

FIG. 4 presents an overview of coded vdmc sequence and bitstream access unit mapping to sub-stream access units (where each square block represents a sub-stream access unit, e.g., atlas access unit, base mesh access unit or arithmetic displacement access unit). A multi-format bitstream 401 (e.g., as part of bitstream 50 of FIG. 1) is shown, where bitstream access units (AUs) contain coded atlas, base mesh, and arithmetic displacement sub-stream access units of the same timestamp. In combination with V1 (301), sub-stream access units A1, B1 and D1 construct an IRAP VDMC access unit (411). Other sub-stream access units corresponding to the same time instance, e.g., A4, B4 and D4 construct a non-IRAP VDMC access unit (422). The multi-format bitstream 401 includes vdmc parameter set (V1) and the following substream access units: A1, B1, D1, A2, B2, D2, A3, B3, D3, A4, B4, D4, A5, B5, D5, A6, B6, and D6.

The access units A, B, C correspond to different formats, e.g., atlas (A) and base-mesh (B) in one substream, instead of storing them separately in different substreams. These may be considered to be first signaling that indicate data of the first format and the second format in the multi-format bitstream (and additional format(s) if a displacement, D, or a further bitstream is used).

First signaling can for example be implemented by introducing the V-DMC parameter set 301, where one can, for example, say that layer X corresponds to NAL units that are encoded using an atlas codec, and Layer Y corresponds to NAL units that are encoded using a base mesh codec.

Second signaling allows an encoder or decoder to map these NAL units to correct formats. That is, one intention is to indicate per NAL unit these identifiers. So, if one is using layer IDs X and Y, for respective codecs A and B, these layer IDs have to be used in the NAL units of the codec bitstream so that decoder can later feed them to the correct decoder instance. Layer IDs are only one example for indicating the relationship between NAL units and the formats, though this relationship could be signaled via other techniques as described herein.

A similar method can be deployed in LCEVC, where an LCEVC encoder (such as encoder 30 of FIG. 1) creates a base bitstream containing video syntax elements and addition enhancement (LCEVC) bitstream. The encoder 30 creates a single bitstream 50 that represents a base bitstream and an enhancement (LCEVC) bitstream.

Examples are as follows. A method may include the following:
1) obtaining two or more bitstreams of a content representation, wherein at least a first of the two or more bitstreams is encoded according a first format and a second of the two or more bitstreams is encoded according a second format;
2) merging the bitstreams of a content representation into a bitstream of a multi-format bitstream;
3) including signaling, to indicate data of the first format and the second format in a multi-format bitstream; and
4) including signaling, to indicate relation between the first format and the second format in the multi-format bitstream.

Another way to address #4 is the following: including signaling to indicate mapping of network abstraction layer units between the first format and the second format in the multi-format bitstream.

Another method includes the following:
1) providing the multi-format bitstream to a decoder; and
2) providing the one or more signaling elements, in or along said bitstream to the decoder.

A further method includes the following:
1) receiving a multi-format bitstream in a decoder;
2) receiving in said multi-format bitstream one or more signaling elements indicate data of a first format and data of a second format in the multi-format bitstream;
3) receiving in said bitstream one or more signaling elements indicating relation between the first format and the second format in the multi-format bitstream;
4) separating, from said bitstream, data having the first format and related data having the second format.
5) decoding the first format data and related second format data.

Additional detail is now presented. For VDMC, in one embodiment, a content representation is a mesh representation. In one embodiment, the first format is an atlas coding format that specifies decoding of atlas information, the second format is a base mesh format that specifies decoding of base mesh representation.

In one embodiment, there is third format, an arithmetic coded displacement format, that specifies decoding of a displacement representation.

In one embodiment, the one or more signaling elements (as signaling) indicate data of the first format and the second format and the third format in multi-format bitstream is or are stored in a new syntax structure. For example, a VDMC parameter set syntax structure may be defined. VDMC parameter set syntax structure contains common information to atlas, base mesh, and displacement formats.

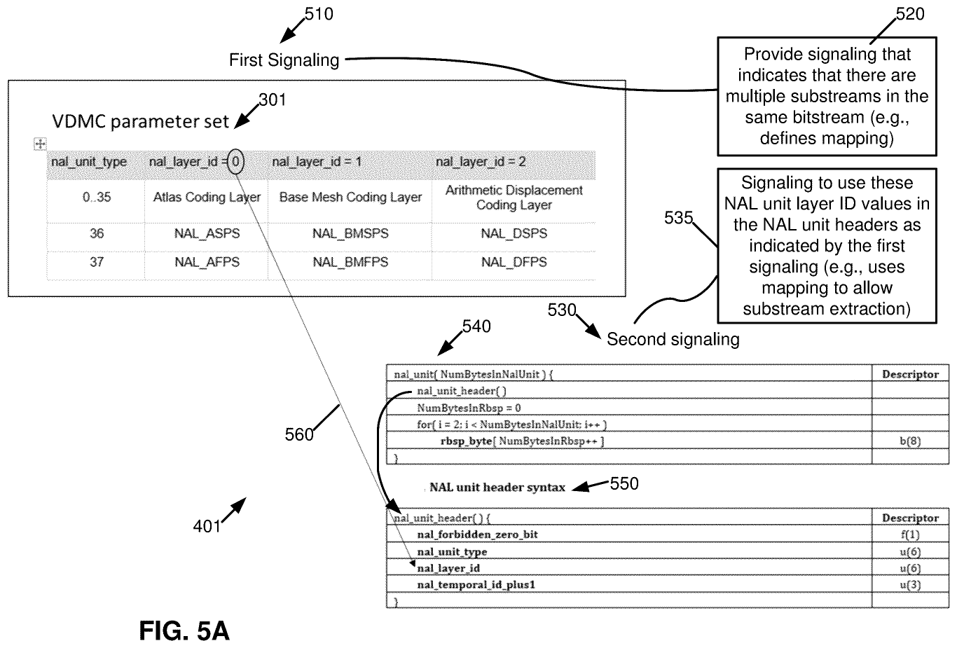

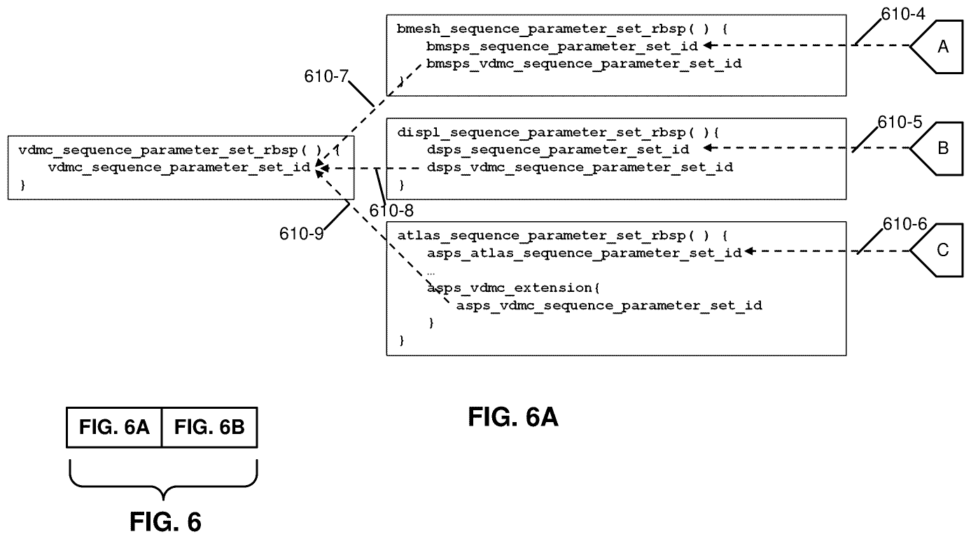

In one embodiment, a VDMC parameter set syntax structure contains syntax elements that allow identification of which NAL units contain which type of data. For example, the structure may contain mapping information of NAL unit layers to data contained as presented in Table 1, which is illustrated in FIG. 5, which has an example layer-to-data type mapping.

In this example, the nal_unit_type has values 0 (zero) to 37, and values 0-35 correspond to the first row, value 36 corresponds to the second row, and value 37 corresponds to the third row. The value of nal_layer_id of zero, one, or two selects one of three columns: a value of zero selects NAL_NSPS for 36 or NAL_AFPS for 37; a value of one selects NAL_BMSPS for 36 or NAL_BMFPS for 37; and a value of two selects NAL_DSPS for 36 or NAL_DFPS for 37.

Turning to FIG. 5A, this figure is an illustration and flowchart using the table of FIG. 5 and other information to illustrate first and second signaling used in a multi-format bitstream. In FIG. 5A, there is first signaling 510 and second signaling 530, which are included in the multi-format bitstream 401. The table (Table 1) of FIG. 5 is illustrated as being part of the VDMC parameter set 301. This first signaling 510 (see block 520) provides signaling that indicates that there are multiple substreams in the same bitstream. For example, this is the VDMC parameter set 301, which contains mapping information, e.g., saying that NAL unit layer ID 1 corresponds to the atlas substream (e.g., 310), and NAL unit layer ID 2 corresponds to base mesh substream e.g., 330). That is, the first signaling 510 defines mapping to the substreams.

The second signaling 530 in this example includes a nal_unit 540 that contains a nal_unit_header 550 as shown. Reference 560 indicates a relationship from the nal_layer_id of zero in the VDMC parameter set 301 to the NAL unit header syntax 550 and a corresponding nal_layer_id. As indicated by block 535, the second signaling is signaling to use these NAL unit layer ID values in the NAL unit headers as indicated by the first signaling. That is, the second signaling 530 uses mapping to allow substream extraction. In the example where nal_layer_id=0, this indicates an atlas coding layer

In one embodiment, a VDMC parameter set syntax structure contains information about the profiles, tiers, and/or levels, of each of the different formats the structure contains.

In one embodiment, a VDMC parameter set syntax structure is stored in a NAL unit type in atlas bitstream, for example nal_unit_type equal to 51.

In one embodiment, a VDMC parameter set syntax structure is stored in a Common Atlas Parameter Set syntax structure (common_atlas_sequence_parameter_set_rbsp in ISO/IEC 23090-5:2023) as an extension.

In one embodiment, a VDMC parameter set syntax structure is identifiable by a syntax element (e.g., ID). In one embodiment, this syntax element is within a V-DMC parameter set syntax structure. In another embodiment it can be a syntax element of a syntax structure that contain the V-DMC parameter set syntax structure, e.g., casps_common_atlas_sequence_parameter_set_id.

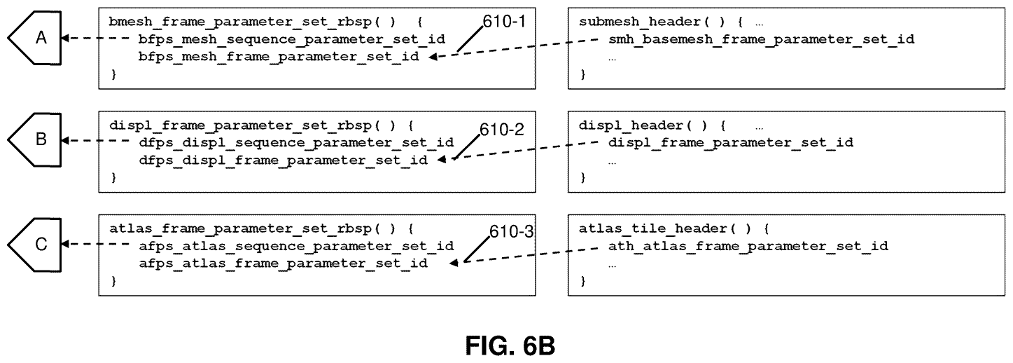

In one embodiment, atlas parameter sequence parameter set, base mesh sequence parameter set, and displacement sequence parameter set syntax structures contain a syntax element that provide linkage to a VDMC parameter set syntax element by indicating the ID of a V-DMC parameter set syntax element. See the example presented on FIG. 6, which is split over FIGS. 6A and 6B, and is an example of a relation between the different syntax structures in an atlas bitstream indicated by IDs. In FIG. 6B, there are the following linkages 610: smh_basemesh_frame_parameter_set_id that provides a linkage 610-1 to a bfps_mesh_frame parameter_set_id; displ_frame_parameter_set_id that provides a linkage 610-2 to a dfps_displ_frame parameter_set_id; ath_atlas_frame_parameter_set_id that provides a linkage 610-3 to an afps_atlas_frame parameter_set_id.

The linkages 610 that span FIGS. 6A and 6B are the following: bfps_mesh_sequence_parameter_set_id provides a linkage 610-4 to a bmsps_sequence_parameter_set_id; dfps_displ_sequence_parameter_set_id provides a linkage 610-5 to a dsps_sequence_parameter_set_id; and afps_atlas_sequence_parameter_set_id provides a linkage 610-6 to an asps_atlas_sequence_parameter_set_id. Three additional linkages 610 are as follows in FIG. 6A: each of bmsps_vdmc_sequence_parameter_set_id, dsps_vdmc_sequence_parameter_set_id, or asps_vdmc_sequence_parameter_set_id provides a respective linkage 610-7, 610-8, and 610-9 to a vdmc_sequence_parameter_set_id.

In one embodiment, an atlas_sequence_parameter_set_rbsp syntax structure contains an extension that provide a syntax element indicating the ID of related V-DMC parameter set syntax element.

In one embodiment, a specific NAL unit type is defined for an auxiliary bitstream (e.g., base mesh or arithmetically coded displacement bitstream) in an atlas bitstream. The atlas bitstream basically becomes a multi-format bitstream when additional bitstreams are merged to it. It is still technically an atlas bitstream, but can be considered a multi-format bitstream too. The new type indicates that an extra header byte is following the NAL unit header bit. The extra header byte allows to indicate what kind of auxiliary bitstream is present in the NAL unit.

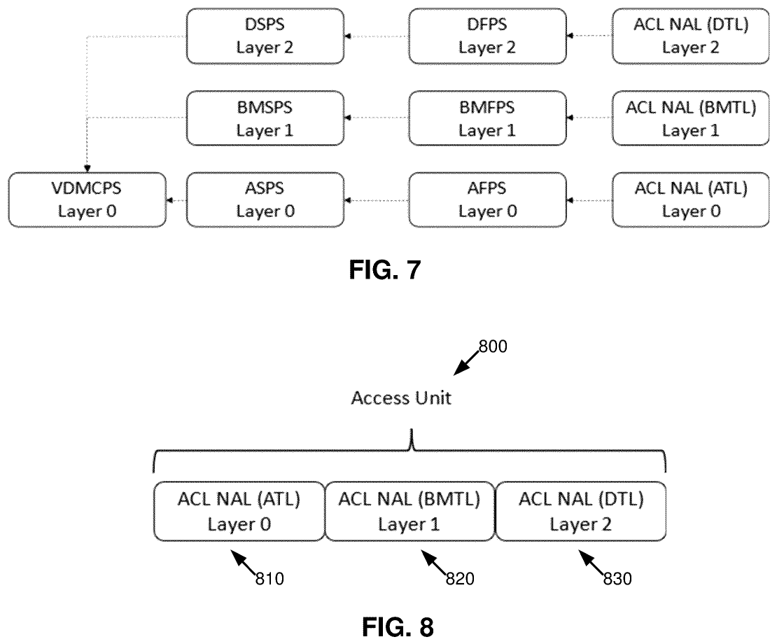

FIG. 7 illustrates an example of relation of NAL units in an atlas bitstream. This example shows three layers: Layer 0 (relating in general to atlas); Layer 1 (relating in general to a base mesh); and Layer 2 (relating in general to displacement). For Layer 0, the ACL NAL (ATL) relates to the AFPS, which relates to the ASPS, which relates to the VDMCPS. For Layer 1, the ACL NAL (BMTL) relates to the BMFPS, which relates to the BMSPS, which relates to the VDMCPS. For Layer 2, the ACL NAL (DTL) relates to DFPS, which relates to DSPS, which relates to the VDMCPS.

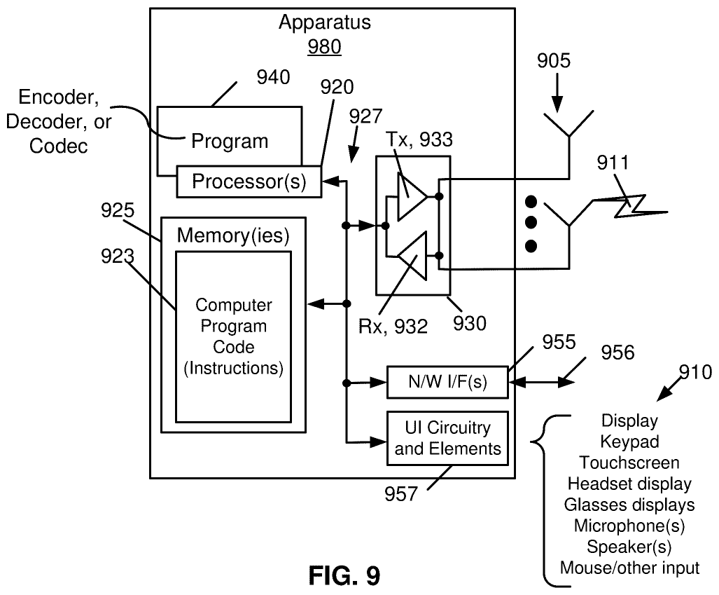

In one embodiment, the data from two or more formats that contain exactly one coded content representation (e.g., exactly one coded picture, or exactly one coded mesh frame) are consecutively placed and merged into a multi-format bitstream. For example, NAL units representing atlas, base mesh, and displacement that represent one mesh frame are placed one after another, see FIG. 8, and form an access unit 800. The example of FIG. 8 has the access unit 800 having an ACL NAL (ATL) 810, an ACL NAL (BMTL) 820, and an ACL NAL (DTL) 830, each placed one after another, starting with 810.

LCEVC is now described. In one embodiment, a content representation is a video representation.

In another embodiment, the first format is a video coding format that specifies decoding of an independent layer, such as AVC, HEVC, or VVC, and the second format is a video coding format that specifies decoding of enhancement data, such as LCEVC.

In one embodiment, the one or more signaling elements (as signaling) that indicate data of the first format and the second format in multi-format bitstream are one or more SEI messages according to the first format. For example, an SEI message may be defined to indicate that data units of the first format on an indicated scalability layer include data of the second format. The SEI message type may be indicative of the second format and/or the SEI message may comprise one or more syntax elements indicating the second format. An externally decoded layer SEI message is presented below as one example:

| | Descriptor |
|---|---|
| externally_decoded_layer( payloadSize ) { | |
| edl_layer_id | ue(v) |
| edl_format_id | ue(v) |
| } | |

edl_layer_id indicates the layer identifier of the layer where the NAL unit payloads are decoded with another decoding process than the decoding process for this bitstream. edl_format_id indicates the decoding process used to decode the NAL unit payloads of the layer with the layer identifier equal to edl_layer_id.

It is to be understood that the syntax and semantics presented above are merely examples and embodiments could be similarly realized with other syntax and semantics. For example, edl_layer_id may not be present in the SEI message but inferred from the layer identifier of the NAL unit header of the SEI NAL unit that contains the externally decoded layer SEI message. In the example, edl_format_id may be an unsigned integer for which values are registered or specified, e.g., in a standard. It needs to be understood that edl_format_id may have another data type, e.g., edl_format_id may be a character string that specifies a URI indicative of the second format. In another example, the payload type value of the SEI message defines the second format. For example, an LCEVC layer SEI message can be specified to indicate that NAL units of the indicated layer comprise LCEVC data.

In one embodiment, the data unit types of the second format are mapped to the data unit types of the first format. For example, an LCEVC non-IDR segment NAL unit type (LCEVC_NON_IDR) may be mapped to the NAL unit type in the time-aligned VCL NAL unit of the independent layer of the first format. In one embodiment, an encoder 30 or another entity creates the multi-format bitstream according to the mapping. Non-IDR frames generally depend on other frames for decoding. In one embodiment, an entity, such as a selective forwarding unit or a media mixer (e.g., as part of an encoder 30), prunes the bitstream based on data unit headers of the first format. For example, the entity may start transmitting a second layer starting from a NAL unit that has a NAL unit header indicating an IDR NAL unit. Such a layer up-switching may be used, for example, to adapt the bitrate by selecting one or both layers of the bitstream to be adaptively forwarded. A benefit of this example is that the entity needs not be aware of the second format.

In one embodiment, the data unit types of the mentioned formats are interleaved in the multi-format bitstream based on their joint usage in time. For example, data units of the first formant, second format and third format, which correspond to the same representation in the presentation time order, may be adjacently placed in the bitstream to allow minimum amount of buffering before playback starts. There may also be multiple data units of each format in this interleaving pattern, even uneven distribution of the formats, so that overall bitstream bandwidth allocation is more evenly distributed in time during downloading process.

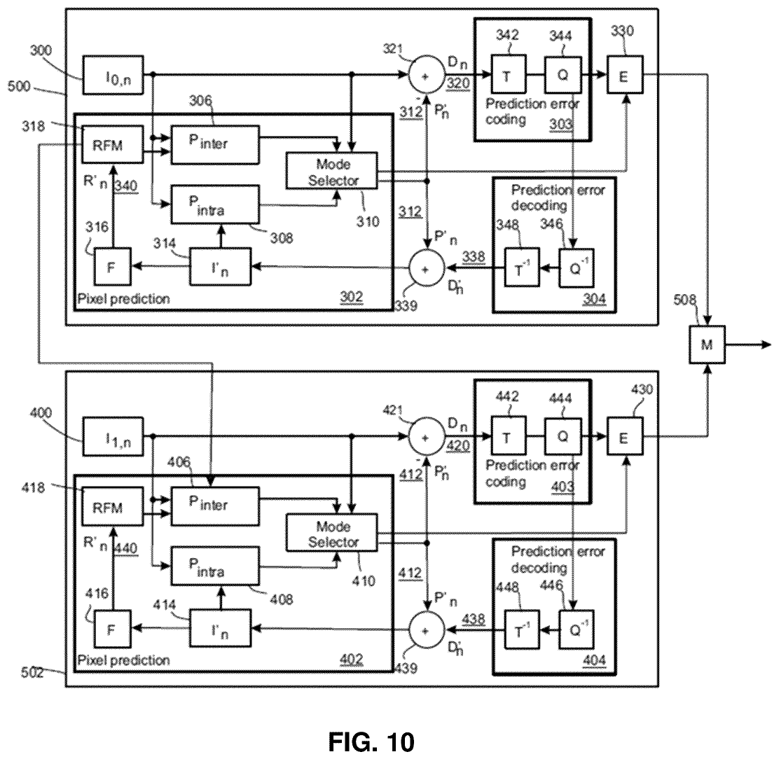

Turning to FIG. 9, this figure is an example of a block diagram of an apparatus suitable for implementing any of the encoders 30 (and corresponding apparatus 80-1) or decoders 40 (and corresponding apparatus 80-2 described herein. The apparatus 980 includes circuitry comprising one or more processors 920, one or more memories 925, one or more transceivers 930, one or more network (N/W) interface(s) (I/F(s)) 955 and user interface (UI) circuitry and elements 957, interconnected through one or more buses 927. Depending on implementation, some apparatus may not have all of the circuitry. For example, an apparatus 980 might not have UI circuitry and elements 957, if it is implemented as a server. An apparatus may have additional circuitry, not described here. FIG. 9 is presented merely as an example.

Each of the one or more transceivers 930 includes a receiver, Rx, 932 and a transmitter, Tx, 933. The one or more buses 927 may be address, data, and/or control buses, and may include any interconnection mechanism, such as a series of lines on a motherboard or integrated circuit, fiber optics or other optical communication equipment, and the like. The one or more transceivers 930 are connected to one or more antennas 905, and may communicate using wireless link 911.

The one or more memories 925 include computer program code 923 comprising instructions. The apparatus 980 includes a program 940. The program 940 may implement an encoder 30, a decoder 40, or a codec (coder/decoder), which implements both encoding and decoding. The program 940 itself may be implemented in a number of ways. The program 940 may be implemented in hardware, such as being implemented as part of the one or more processors 920. The program 940 may be implemented also as an integrated circuit or through other hardware such as a programmable gate array. In another example, the program 940 may be implemented as computer program code (having corresponding instructions) 923 and is executed by the one or more processors 920. For instance, the one or more memories 925 store instructions that, when executed by the one or more processors 920, cause the apparatus 980 to perform one or more of the operations as described herein. Furthermore, the one or more processors 920, one or more memories 925, and example algorithms (e.g., as flowcharts and/or signaling diagrams), encoded as instructions, programs, or code, are means for causing performance of the operations described herein.

The network interface(s) (N/W I/F(s)) 955 are wired interfaces communicating using link(s) 956, which could be fiber optic or other wired interfaces. The apparatus 980 could include only wireless transceiver(s) 930, only N/W I/Fs 955, or both wireless transceiver(s) 930 and N/W I/Fs 955.

The apparatus 980 may or may not include UI circuitry and elements 957. These could include elements 910 such as the following: a display, a keypad, a touchscreen, a headset display, glasses displays, microphone(s), speaker(s) and/or mouse/or other input. The element 910 implemented will depend on the actual apparatus 980. For instance, an apparatus 980 of a smartphone would typically include at least a touchscreen, speakers, and microphones. Headset displays could include screen(s) or other projection mechanisms, speakers, and microphones The UI circuitry and elements 957 may also include circuitry to communicate with external UI elements 910 such as displays, keyboards, mice, headsets, and the like.

The computer readable memories 925 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 925 may be means for performing storage and retrieval functions. The processors 920 may be of any type suitable to the local technical environment, and may include one or more of general-purpose computers, special purpose computers, microprocessors, digital signal processors (DSPs) and processors based on a multi-core processor architecture, as non-limiting examples. The processors 920 may be means for performing functions, such as controlling the apparatus 980, and other functions as described herein.

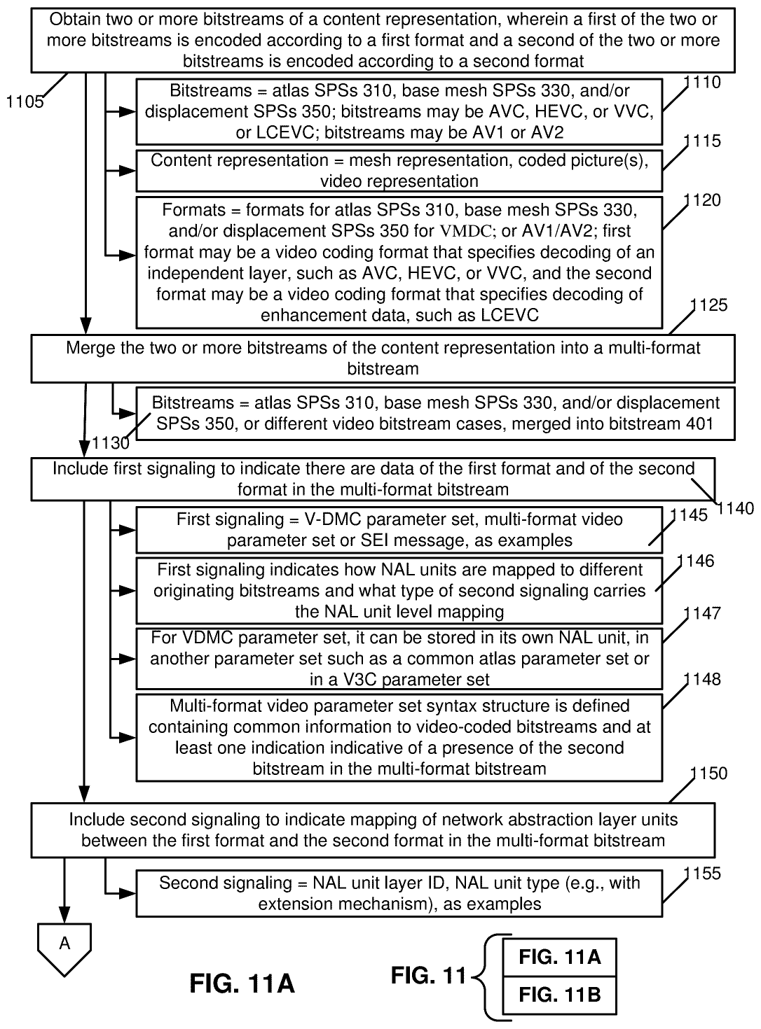

Turning to FIG. 10, this figure shows a block diagram of a general structure of a video encoder for two layers. FIG. 10 presents an encoder for two layers, but it would be appreciated that presented encoder could be similarly extended to encode more than two layers or a single layer. FIG. 10 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 10 also shows an embodiment of the pixel predictor 302, 402 as comprising an inter-frame predictor 306, 406 (Pinter), an intra-frame predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives base layer pictures 300 as images (I_{0,n}) of a video stream to be encoded at both the inter-frame predictor 306 (which determines the difference between the image and a motion compensated reference frame from reference frame memory 318) and the intra-frame predictor 308 (which determines a prediction for an image block based only on the already processed parts of the current frame or picture). The output of both the inter-frame predictor and the intra-frame predictor are passed to the mode selector 310. The intra-frame predictor 308 may have more than one intra-frame prediction mode. Hence, each mode may perform the intra-frame prediction and provide the predicted signal to the mode selector 310. The mode selector 310 also receives a copy of the base layer picture 300. Correspondingly, the pixel predictor 402 of the second encoder section 502 receives enhancement layer pictures 400 as images (I_{1,n}) of a video stream to be encoded at both the inter-frame predictor 406 (which determines the difference between the image and a motion compensated reference frame in the reference frame memory 418) and the intra-frame predictor 408 (which determines a prediction for an image block based only on the already processed parts of the current frame or picture). The output of both the inter-frame predictor and the intra-frame predictor are passed to the mode selector 410. The intra-frame predictor 408 may have more than one intra-frame prediction modes. Hence, each mode may perform the intra-frame prediction and provide the predicted signal to the mode selector 410. The mode selector 410 also receives a copy of the enhancement layer picture 400.

Depending on which encoding mode is selected to encode the current block, the output of the inter-frame predictor 306, 406 or the output of one of the optional intra-frame predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor (a second summing device) 339, 439 the combination of the prediction representation of the image block 312, 412 (P′ₙ) and the output (prediction error signal) 338, 438 (D′ₙ) of the prediction error decoder 304, 404. The preliminary reconstructed image 314, 414 (I′ₙ) may be passed to the intra-frame predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-frame predictor 306 to be used as the reference image against which a future base layer picture 300 is compared in inter-frame prediction operations. Subject to the base layer being selected and indicated to be the source for inter-layer sample prediction and/or inter-layer motion information prediction of the enhancement layer according to some embodiments, the reference frame memory 318 may also be connected to the inter-frame predictor 406 to be used as the reference image against which a future enhancement layer picture 400 is compared in inter-frame prediction operations. Moreover, the reference frame memory 418 may be connected to the inter-frame predictor 406 to be used as the reference image against which a future enhancement layer picture 400 is compared in inter-frame prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g., the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g., DCT (discrete cosine transform) coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream, e.g., by a multiplexer 508 (M).

Turning to FIG. 11, split over FIGS. 11A and 11B, this figure illustrates a method for encoding. This is assumed to be performed by an encoder 30 (forming part of or otherwise by an apparatus 980).

The encoder 30 obtains (block 1105) two or more bitstreams of a content representation, wherein a first of the two or more bitstreams is encoded according to a first format and a second of the two or more bitstreams is encoded according to a second format. Blocks 1110, 1115, and 1120 are examples of block 1105. In block 1110, the bitstreams can be the atlas SPSs 311, base mesh SPSs 331, and/or displacement SPSs 350. As previously described, the atlas SPSs 311 and base mesh SPSs 331 would be bitstreams in a typical implementation, and displacement SPSs 350 would generally be added to those. The displacement SPSs 350 can be a third format arithmetic coded displacement format that specifies decoding of displacement representation. It is possible, however, to have other bitstreams, such as in the LCEVC case. The latter would have bitstreams that may be AVC, HEVC, or VVC, or LCEVC. Further bitstreams could include AV1 or AV2 bitstreams. Block 1115 indicates that the content representation could be a mesh representation or coded picture(s) (e.g., for VMDC), or video representation (e.g., for LCEVC). The formats in block 1120 may be formats for atlas SPSs 311, base mesh SPSs 331, and/or displacement SPSs 350, for VMDC; or AV1/AV2. For LCEVC, the first format may be a video coding format that specifies decoding of an independent layer, such as AVC, HEVC, or VVC, and the second format may be a video coding format that specifies decoding of enhancement data, such as LCEVC.

In block 1125, the encoder 30 merges the two or more bitstreams of the content representation into a multi-format bitstream. In an example, this is illustrated as (block 1130) the bitstreams being the atlas SPSs 311, base mesh SPSs 331, and/or displacement SPSs 350, or different video bitstream cases, and merged into multi-format bitstream 401. That is, using the methods herein, one should be able to add different video bitstreams in the same multi-format bitstream.

In block 1140, the encoder includes first signaling to indicate data of the first format and of the second format in the multi-format bitstream. As previously described, the NAL units A, B, C (see FIGS. 3 and 4) correspond to different formats, e.g., atlas and base-mesh in one substream, instead of storing them separately in different substreams. For example, a Layer X corresponds to NAL units that are encoded using an atlas codec (as part of the encoder 30), and a Layer Y corresponds to NAL units that are encoded using a base mesh codec (as part of the encoder 30). This is indicated in block 1145 as the first signaling being a V-DMC parameter set. For LCEVC, similar NAL units could correspond to AVC, HEVC, or VVC (as one bitstream merged into the multi-format bitstream), or LCEVC (as another bitstream merged into the multi-format bitstream). This is indicated in block 1145 as the first signaling being a multi-format video parameter set, where LCEVC is one such bitstream that could be used. The multi-format video parameter set may, for example, comprise a mapping of layer identifier values, sublayer identifier values, and/or NAL unit type values to a codec, which may be further characterized, for example, by a codec profile, a codec level, and/or other characteristics. The mapping may be provided for a set of units (e.g., a set of layers, sublayers, or NAL unit types) or for an individual unit (a single layer, sublayer, or NAL unit type). The first signaling may additionally or alternatively include SEI messages, such as the externally decoded layer SEI message described above. For example, the mapping provided in the multi-format video parameter set may indicate that indicated layer(s), sublayer(s) and/or NAL unit type value(s) carrying the second bitstream are indicated to be “external”, i.e., not specified in the first format, and further information may be provided in an SEI message, such as the externally decoded layer SEI message. In an embodiment, the codec profile (e.g., a profile indicator value or alike) assigned to the indicated layer(s), sublayer(s) and/or NAL unit type value(s) carrying the second bitstream indicates is indicated to be “external”, i.e., not specified in the first format, and further information may be provided in an SEI message, such as the externally decoded layer SEI message.

As a more general description, block 1146 indicates that the first signaling indicates how NAL units are mapped to different originating bitstreams and what type of second signaling carries the NAL unit level mapping. In block 1147, another example is where, for a VDMC parameter set, it can be stored in its own NAL unit, in another parameter set such as common atlas parameter set, or in a V3C parameter set. See, e.g., FIG. 3 and vmdc parameter set 301, as one example where a new NAL unit dedicated for carrying VDMC parameter set is used to store the VDMC parameter set. Alternatively, the VDMC parameter set could be embedded in another parameter set or V3C parameter set. In block 1148, a multi-format video parameter set syntax structure is defined containing common information to video-coded bitstreams and at least one indication indicative of a presence of the second bitstream in the multi-format bitstream.

In block 1150, the encoder 30 includes second signaling to indicate mapping of network abstraction layer units between the first format and the second format in the multi-format bitstream. As one example in block 1155, the second signaling may include a NAL unit layer ID, or a NAL unit type (e.g., with an extension mechanism), as examples. This has previously been described via layer IDs (as NAL unit layer IDs) that may be used, for respective codecs, in the corresponding individual NAL units. For instance, if there are two-layer IDs X and Y for respective codecs A and B, a corresponding one of the layer IDs X or Y would be added to an individual NAL unit to indicate the corresponding respective coded of A (for X) or B (for Y). For instance, for FIG. 4, there are NAL units A1, B1, A2, B2, A3, B3 . . . , and A1, A2, A3, . . . would have layer ID X added to their individual NAL units to indicate codec A, while B1, B2, B3, . . . would have layer ID Y added to their individual NAL units to indicate codec B. FIG. 4 also shows D1, D2, D3, . . . , and another layer ID (e.g., Z) could be used for a codec C. As for the NAL unit types (and possible corresponding extension mechanism), consider the example of an atlas SPS rbsp syntax structure modified to contain an extension that provides a syntax element indicating an ID of related V-DMC parameter set syntax element. Other examples are provided herein.

FIG. 11B includes a number of blocks that can modify the flowchart in FIG. 11A or modify individual elements of FIG. 11A. Most of these are further described above too. In block 1165, the encoder 30 configures the V-DMC parameter set syntax structure to contain information about the profiles, tier, and/or level, of each of the different formats contained therein. In block 1167, the encoder 30 stores a V-DMC parameter set syntax structure in a NAL unit in an atlas bitstream. The encoder 30 in block 1169 stores a V-DMC parameter set syntax structure in a Common Atlas Parameter Set syntax structure as an extension.

In block 1170, the encoder 30 identifies a V-DMC parameter set syntax structure by a syntax element (e.g., ID), e.g., within a V-DMC parameter set syntax structure; or by a syntax element of a syntax structure that contains the V-DMC parameter set syntax structure. The encoder 30 configures (block 1173) atlas parameter SPS, base mesh SPS (e.g., and displacement SPS) syntax structures to contain a syntax element that provides a linkage to a V-DMC parameter set syntax element by indicating the ID of a V-DMC parameter set syntax element. See the example of FIG. 4. In block 1175, the encoder 30 configures an atlas SPS rbsp syntax structure to contain an extension that provides a syntax element indicating an ID of related V-DMC parameter set syntax element.

Blocks 1170, 1173, and 1175 can be more broadly considered (see reference 1176) to provide mapping (e.g., linking) of parameter sets using an ID. For instance, in each of these, there is an ID in a syntax element that maps to a parameter set. For the purposes of at least these blocks, mapping and linking are considered to be the same. In more detail, for reference 1176, the first signaling comprises a video-based dynamic mesh coding parameter set, which maps, as mapping information, network abstraction layer-unit-type or network abstraction layer-unit-layer-identifications to different substreams of the multi-format bitstream. The second signaling then uses the mapping information to map network abstraction layer units into the different substreams. Blocks 1170, 1173, and 1175 use network abstraction layer-unit-layer-identifications to different substreams of the multi-format bitstream.

Block 1177 has the encoder 30 defining a specific NAL unit type is for auxiliary bitstream(s) (e.g., base mesh and/or arithmetically coded displacement bitstream) in the atlas bitstream. Block 1180 has the encoder 30 consecutively placing data from two or more formats that contain exactly one coded content representation when merged into the multi-format bitstream. The encoder 30 in block 1182 signals information that indicates data of the first format and the second format in a multi-format bitstream is placed in one or more SEI messages according to the first format. In block 1184, the encoder 30 maps data unit types of the second format to the data unit types of the first format.

In block 1186, the encoder 30 prunes the bitstream based on data unit headers of one (e.g., the first) format to be able to start transmitting other (e.g., second) headers from another (e.g., second) format. The encoder in block 1190 interleaves the data unit types of the mentioned formats in the multi-format bitstream based on their joint usage in time. The encoder 30 in block 1195 sends the multi-format bitstream toward a decoder, and sends the first and second signaling, in or along with the multi-format bitstream, toward the decoder.

Referring to FIG. 12, this figure illustrates a method for decoding. This is assumed to be performed by a decoder 40 and by the corresponding apparatus 80-2. The decoder 40 receives a multi-format bitstream in block 1205. In block 1210, the decoder 40 receives in the multi-format bitstream first signaling indicating there are data of the first format and of the second format in the multi-format bitstream.

In block 1230, the decoder receives in the multi-format bitstream second signaling to indicate mapping of network abstraction layer units between the first format and the second format in the multi-format bitstream. The decoder 40 in block 1240 separates, from the multi-format bitstream using the first and second signaling, data having the first format and related data having the second format. The relation is established by the fact that they originated from the same content representation (and this is an encoder side term). In block 1250, the decoder 40 decodes the data having the first formation and related data having the second format. In block 1260, the decoder outputs the decoded data for presentation to a user.

Without in any way limiting the scope, interpretation, or application of the claims appearing below, a technical effect and/or advantage of one or more of the example embodiments disclosed herein is the examples provide a clear definition of access unit and the association between atlas/basemesh/displacement. Another technical effect and/or advantage of one or more of the example embodiments disclosed herein is the examples allow re-use of existing single-bitstream systems aspects for the first straightforward deployments. Another technical effect and/or advantage of one or more of the example embodiments disclosed herein is reduction of the amount of separate sub-bitstreams and simplification of systems-level technologies like file formats and streaming protocols.

The following are additional examples.

Example 1. A method, comprising: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

Example 2. The method according to example 1, further comprising: sending the multi-format bitstream toward a decoder; and sending the first and second signaling, in or along with the multi-format bitstream, toward the decoder.

Example 3. The method according to any one of examples 1 to 2, wherein the first format comprises a video coding format that specifies decoding of an independent layer, and wherein the second format comprises a video coding format that specifies decoding of enhancement data.

Example 4. The method according to any one of examples 1 to 2, wherein the first format comprises an atlas format for an atlas sequence parameter set, and wherein the second format comprises a base mesh format for a base mesh sequence parameter set.

Example 5. The method according to any one of examples 1 to 4, wherein the content representation comprises a mesh representation, one or more coded pictures, or a video representation.

Example 6. The method according to any one of examples 1 to 5, wherein the first signaling comprises a video-based dynamic mesh coding parameter set stored in a network abstraction layer unit defined to store the video-based dynamic mesh coding parameter set, stored in another sequence parameter set, or stored in a V3C parameter set.

Example 7. The method according to example 6, wherein the first signaling comprises the video-based dynamic mesh coding parameter set, which maps, as mapping information, network abstraction layer-unit-type or network abstraction layer-unit-layer-identifications to different substreams of the multi-format bitstream, and wherein the second signaling then uses the mapping information to map network abstraction layer units into the different substreams.

Example 8. The method according to example 7, wherein network abstraction layer-unit-layer-identifications to different substreams of the multi-format bitstream are used and one of the following is used: identifications are within a video-based dynamic mesh coding parameter set syntax structures and identify another video-based dynamic mesh coding parameter set syntax structure; or the identifications are configured in one or more of an atlas parameter sequence parameter set, a base mesh sequence parameter set, or a displacement sequence parameter set and identify a video-based dynamic mesh coding parameter set syntax element; or the identifications are configured in an extension of an atlas sequence parameter set raw byte sequence payload syntax structure to identify a related video-based dynamic mesh coding parameter set syntax element.

Example 9. The method according to any one of examples 1 to 5, wherein the first signaling comprises a multi-format video parameter set syntax structure defined to contain common information to video-coded bitstreams and at least one indication indicative of a presence of the second bitstream in the multi-format bitstream.

Example 10. The method according to any one of examples 1 to 9, wherein the second signaling, which uses mapping information from the first signaling, comprises one of the following: identifications in corresponding network abstraction layer unit layers; or network abstraction layer unit types.

Example 11. The method according to example 6, wherein the video-based dynamic mesh coding parameter set has a syntax structure comprising information about profiles, tier, and/or level of each of multiple different formats contained therein.

Example 12. The method according to example 6, wherein the video-based dynamic mesh coding parameter set has a syntax structure stored in a network abstraction layer unit in an atlas bitstream.

Example 13. The method according to example 6, wherein the video-based dynamic mesh coding parameter set has a syntax structure stored in a in common atlas parameter set syntax structure as an extension.

Example 14. The method according to any one of examples 1 to 13, wherein a specific network abstraction layer unit type is defined in an atlas bitstream, of the multi-format bitstream, for one or more auxiliary bitstreams comprising one or both of a base mesh bitstream or arithmetically coded displacement bitstream.

Example 15. The method according to any one of examples 1 to 14, wherein the merging comprises consecutively placing data from two or more formats that contain exactly one coded content representation when merged into the multi-format bitstream.

Example 16. The method according to any one of examples 1 to 15, wherein signal information that indicates data of the first format and the second format in a multi-format bitstream is placed in one or more supplemental enhancement information messages according to the first format.

Example 17. The method according to any one of examples 1 to 16, wherein the first signaling maps data unit types of the second format to data unit types of the first format.

Example 18. The method according to any one of examples 1 to 17, wherein the merging comprises pruning the multi-format bitstream based on data unit headers of one of the first and second formats to be able to start transmitting other headers from an other of the first and second formats.

Example 19. The method according to any one of examples 1 to 18, wherein the merging comprises interleaving data unit types of the first and second formats in the multi-format bitstream based on their joint usage in time.

Example 20. A method, comprising: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

Example 21. The method according to example 20, further comprising outputting the decoded data for presentation to a user.

Example 22. A computer program, comprising instructions for performing the methods of any of examples 1 to 21, when the computer program is run on an apparatus.

Example 23. The computer program according to example 22, wherein the computer program is a computer program product comprising a computer-readable medium bearing instructions embodied therein for use with the apparatus.

Example 24. The computer program according to example 22, wherein the computer program is directly loadable into an internal memory of the apparatus.

Example 25. An apparatus comprising means for performing: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

Example 26. The apparatus according to example 25, wherein the means are further configured for performing: sending the multi-format bitstream toward a decoder; and sending the first and second signaling, in or along with the multi-format bitstream, toward the decoder.

Example 27. The apparatus according to any one of examples 25 to 26, wherein the first format comprises a video coding format that specifies decoding of an independent layer, and wherein the second format comprises a video coding format that specifies decoding of enhancement data.

Example 28. The apparatus according to any one of examples 25 to 26, wherein the first format comprises an atlas format for an atlas sequence parameter set, and wherein the second format comprises a base mesh format for a base mesh sequence parameter set.

Example 29. The apparatus according to any one of examples 25 to 28, wherein the content representation comprises a mesh representation, one or more coded pictures, or a video representation.

Example 30. The apparatus according to any one of examples 25 to 29, wherein the first signaling comprises a video-based dynamic mesh coding parameter set stored in a network abstraction layer unit defined to store the video-based dynamic mesh coding parameter set, stored in another sequence parameter set, or stored in a V3C parameter set.

Example 31. The apparatus according to example 30, wherein the first signaling comprises the video-based dynamic mesh coding parameter set, which maps, as mapping information, network abstraction layer-unit-type or network abstraction layer-unit-layer-identifications to different substreams of the multi-format bitstream, and wherein the second signaling then uses the mapping information to map network abstraction layer units into the different substreams.

Example 32. The apparatus according to example 31, wherein network abstraction layer-unit-layer-identifications to different substreams of the multi-format bitstream are used and one of the following is used: identifications are within a video-based dynamic mesh coding parameter set syntax structures and identify another video-based dynamic mesh coding parameter set syntax structure; or the identifications are configured in one or more of an atlas parameter sequence parameter set, a base mesh sequence parameter set, or a displacement sequence parameter set and identify a video-based dynamic mesh coding parameter set syntax element; or the identifications are configured in an extension of an atlas sequence parameter set raw byte sequence payload syntax structure to identify a related video-based dynamic mesh coding parameter set syntax element.

Example 33. The apparatus according to any one of examples 25 to 29, wherein the first signaling comprises a multi-format video parameter set syntax structure defined to contain common information to video-coded bitstreams and at least one indication indicative of a presence of the second bitstream in the multi-format bitstream.

Example 34. The apparatus according to any one of examples 25 to 33, wherein the second signaling, which uses mapping information from the first signaling, comprises one of the following: identifications in corresponding network abstraction layer unit layers; or network abstraction layer unit types.

Example 35. The apparatus according to example 30, wherein the video-based dynamic mesh coding parameter set has a syntax structure comprising information about profiles, tier, and/or level of each of multiple different formats contained therein.

Example 36. The apparatus according to example 30, wherein the video-based dynamic mesh coding parameter set has a syntax structure stored in a network abstraction layer unit in an atlas bitstream.

Example 37. The apparatus according to example 30, wherein the video-based dynamic mesh coding parameter set has a syntax structure stored in a in common atlas parameter set syntax structure as an extension.

Example 38. The apparatus according to any one of examples 25 to 37, wherein a specific network abstraction layer unit type is defined in an atlas bitstream, of the multi-format bitstream, for one or more auxiliary bitstreams comprising one or both of a base mesh bitstream or arithmetically coded displacement bitstream.

Example 39. The apparatus according to any one of examples 25 to 38, wherein the merging comprises consecutively placing data from two or more formats that contain exactly one coded content representation when merged into the multi-format bitstream.

Example 40. The apparatus according to any one of examples 25 to 39, wherein signal information that indicates data of the first format and the second format in a multi-format bitstream is placed in one or more supplemental enhancement information messages according to the first format.

Example 41. The apparatus according to any one of examples 25 to 40, wherein the first signaling maps data unit types of the second format to data unit types of the first format.

Example 42. The apparatus according to any one of examples 25 to 41, wherein the merging comprises pruning the multi-format bitstream based on data unit headers of one of the first and second formats to be able to start transmitting other headers from an other of the first and second formats.

Example 43. The apparatus according to any one of examples 25 to 42, wherein the merging comprises interleaving data unit types of the first and second formats in the multi-format bitstream based on their joint usage in time.

Example 44. An apparatus comprising means for performing: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

Example 45. The apparatus according to example 44, further comprising outputting the decoded data for presentation to a user.

Example 46. The apparatus of any preceding apparatus example, wherein the means comprises: at least one processor; and at least one memory storing instructions that, when executed by at least one processor, cause the performance of the apparatus.

Example 47. An apparatus, comprising: one or more processors; and one or more memories storing instructions that, when executed by the one or more processors, cause the apparatus at least to perform: obtaining two or more bitstreams of a content representation, wherein a first of the two or more bitstreams is encoded according to a first format and a second of the two or more bitstreams is encoded according to a second format; merging the two or more bitstreams of the content representation into a multi-format bitstream; including first signaling to indicate there are data of the first format and of the second format in the multi-format bitstream; and including second signaling to indicate mapping of network abstraction layer units between the first format and the second format in the multi-format bitstream.

Example 48. The apparatus according to example 47, wherein the one or more memories further store instructions that, when executed by the one or more processors, cause the apparatus at least to perform: sending the multi-format bitstream toward a decoder; and sending the first and second signaling, in or along with the multi-format bitstream, toward the decoder.

Example 49. The apparatus according to any one of examples 47 to 48, wherein the first format comprises a video coding format that specifies decoding of an independent layer, and wherein the second format comprises a video coding format that specifies decoding of enhancement data.

Example 50. The apparatus according to any one of examples 47 to 48, wherein the first format comprises an atlas format for an atlas sequence parameter set, and wherein the second format comprises a base mesh format for a base mesh sequence parameter set.

Example 51. The apparatus according to any one of examples 47 to 50, wherein the content representation comprises a mesh representation, one or more coded pictures, or a video representation.

Example 52. The apparatus according to any one of examples 47 to 51, wherein the first signaling comprises a video-based dynamic mesh coding parameter set stored in a network abstraction layer unit defined to store the video-based dynamic mesh coding parameter set, stored in another sequence parameter set, or stored in a V3C parameter set.

Example 53. The apparatus according to example 52, wherein the first signaling comprises the video-based dynamic mesh coding parameter set, which maps, as mapping information, network abstraction layer-unit-type or network abstraction layer-unit-layer-identifications to different substreams of the multi-format bitstream, and wherein the second signaling then uses the mapping information to map network abstraction layer units into the different substreams.

Example 54. The apparatus according to example 53, wherein network abstraction layer-unit-layer-identifications to different substreams of the multi-format bitstream are used and one of the following is used: identifications are within a video-based dynamic mesh coding parameter set syntax structures and identify another video-based dynamic mesh coding parameter set syntax structure; or the identifications are configured in one or more of an atlas parameter sequence parameter set, a base mesh sequence parameter set, or a displacement sequence parameter set and identify a video-based dynamic mesh coding parameter set syntax element; or the identifications are configured in an extension of an atlas sequence parameter set raw byte sequence payload syntax structure to identify a related video-based dynamic mesh coding parameter set syntax element.

Example 55. The apparatus according to any one of examples 47 to 51, wherein the first signaling comprises a multi-format video parameter set syntax structure defined to contain common information to video-coded bitstreams and at least one indication indicative of a presence of the second bitstream in the multi-format bitstream.

Example 56. The apparatus according to any one of examples 47 to 55, wherein the second signaling, which uses mapping information from the first signaling, comprises one of the following: identifications in corresponding network abstraction layer unit layers; or network abstraction layer unit types.

Example 57. The apparatus according to example 52, wherein the video-based dynamic mesh coding parameter set has a syntax structure comprising information about profiles, tier, and/or level of each of multiple different formats contained therein.

Example 58. The apparatus according to example 52, wherein the video-based dynamic mesh coding parameter set has a syntax structure stored in a network abstraction layer unit in an atlas bitstream.

Example 59. The apparatus according to example 52, wherein the video-based dynamic mesh coding parameter set has a syntax structure stored in a in common atlas parameter set syntax structure as an extension.

Example 60. The apparatus according to any one of examples 47 to 59, wherein a specific network abstraction layer unit type is defined in an atlas bitstream, of the multi-format bitstream, for one or more auxiliary bitstreams comprising one or both of a base mesh bitstream or arithmetically coded displacement bitstream.

Example 61. The apparatus according to any one of examples 47 to 60, wherein the merging comprises consecutively placing data from two or more formats that contain exactly one coded content representation when merged into the multi-format bitstream.

Example 62. The apparatus according to any one of examples 47 to 61, wherein signal information that indicates data of the first format and the second format in a multi-format bitstream is placed in one or more supplemental enhancement information messages according to the first format.

Example 63. The apparatus according to any one of examples 47 to 62, wherein the first signaling maps data unit types of the second format to data unit types of the first format.

Example 64. The apparatus according to any one of examples 47 to 63, wherein the merging comprises pruning the multi-format bitstream based on data unit headers of one of the first and second formats to be able to start transmitting other headers from an other of the first and second formats.

Example 65. The apparatus according to any one of examples 47 to 64, wherein the merging comprises interleaving data unit types of the first and second formats in the multi-format bitstream based on their joint usage in time.

Example 66. An apparatus, comprising: one or more processors; and one or more memories storing instructions that, when executed by the one or more processors, cause the apparatus at least to perform: receiving, by a decoder, a multi-format bitstream; receiving, in the multi-format bitstream, first signaling indicating there are data of a first format and of a second format in the multi-format bitstream; receiving, in the multi-format bitstream, second signaling to indicate mapping of network abstraction layer units between the first format and the second format in the multi-format bitstream; separating, from the multi-format bitstream using the first signaling and the second signaling, data having the first format and related data having the second format; and decoding the data having the first format and the related data having the second format.

Example 67. The apparatus according to example 66, further comprising outputting the decoded data for presentation to a user.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 9. A computer-readable medium may comprise a computer-readable storage medium (e.g., memories 925 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

Some embodiments have been described in relation to specific coding standards, such as V3C. V-DMC and/or LCEVC. It is to be understood that embodiments are not limited to the specific coding standards but apply generally to any coding formats or coding specifications of similar nature.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3D three-dimensional
ACL atlas coding layer
AFPS Atlas frame parameter set
ASPS Atlas sequence parameter set
API application programming interface
ATL Atlas tile layer
AVC advanced video coding
AU access unit
AVC Advanced Video Coding
BMSPS Base mesh sequence parameter set
BMFPS Base mesh frame parameter set
BMTL Base mesh tile layer
CADS Coded arithmetic displacement sequence
CAS coded atlas sequence
CBMS Coded Base Mesh Sequence
CfP call for proposal
codec coder/decoder
CVS coded VDMC sequence
DoF degree of freedom
DSPS Displacement sequence parameter set
DFPS Displacement frame parameter set
DTL Displacement tile layer
FoV field of view
HEVC High Efficiency Video Coding
HLS High Level Syntax
HUD head's up display
ID or id identification
IDR Instantaneous Decoder Refresh
IRAP intra-random access point
LCEVC Low Complexity Enhancement Video Coding
MIV MPEG immersive video
MPEG Motion Picture Experts Group
NAL network abstraction layer
rbsp raw byte sequence payload
SEI Supplemental Enhancement Information
SPS sequence parameter set
URI Uniform Resource Identifier
VVC Versatile Video Coding
V3C Visual volumetric video-based coding
VDMC, vdmc, V-DMC Video-based dynamic mesh coding
VDMCPS Video-based dynamic mesh coding parameter set
V-PCC Video-Based Point Cloud Compression
VPS V3C parameter set
WD working draft

What is claimed is:

1. A method, comprising:
obtaining two or more bitstreams of a content representation, wherein a first of the two or more bitstreams is encoded according to a first format and a second of the two or more bitstreams is encoded according to a second format;
merging the two or more bitstreams of the content representation into a multi-format bitstream;
including first signaling to indicate there are data of the first format and of the second format in the multi-format bitstream; and
including second signaling to indicate mapping of network abstraction layer units between the first format and the second format in the multi-format bitstream.

2. An apparatus, comprising:
one or more processors; and
one or more memories storing instructions that, when executed by the one or more processors, cause the apparatus at least to perform:
obtaining two or more bitstreams of a content representation, wherein a first of the two or more bitstreams is encoded according to a first format and a second of the two or more bitstreams is encoded according to a second format;
merging the two or more bitstreams of the content representation into a multi-format bitstream;
including first signaling to indicate there are data of the first format and of the second format in the multi-format bitstream; and
including second signaling to indicate mapping of network abstraction layer units between the first format and the second format in the multi-format bitstream.

3. The apparatus according to claim 2, wherein the one or more memories further store instructions that, when executed by the one or more processors, cause the apparatus at least to perform:
sending the multi-format bitstream toward a decoder; and
sending the first and second signaling, in or along with the multi-format bitstream, toward the decoder.

4. The apparatus according to claim 2, wherein the first format comprises a video coding format that specifies decoding of an independent layer, and wherein the second format comprises a video coding format that specifies decoding of enhancement data.

5. The apparatus according to claim 2, wherein the first format comprises an atlas format for an atlas sequence parameter set, and wherein the second format comprises a base mesh format for a base mesh sequence parameter set.

6. The apparatus according to claim 2, wherein the first signaling comprises a video-based dynamic mesh coding parameter set stored in a network abstraction layer unit defined to store the video-based dynamic mesh coding parameter set, stored in another sequence parameter set, or stored in a V3C parameter set.

7. The apparatus according to claim 6, wherein the first signaling comprises the video-based dynamic mesh coding parameter set, which maps, as mapping information, network abstraction layer-unit-type or network abstraction layer-unit-layer-identifications to different substreams of the multi-format bitstream, and wherein the second signaling then uses the mapping information to map network abstraction layer units into the different substreams.

8. The apparatus according to claim 2, wherein the first signaling comprises a multi-format video parameter set syntax structure defined to contain common information to video-coded bitstreams and at least one indication indicative of a presence of the second bitstream in the multi-format bitstream.

9. The apparatus according to claim 2, wherein the second signaling, which uses mapping information from the first signaling, comprises one of the following:
identifications in corresponding network abstraction layer unit layers; or
network abstraction layer unit types.

10. The apparatus according to claim 6, wherein the video-based dynamic mesh coding parameter set has a syntax structure comprising information about profiles, tier, and/or level of each of multiple different formats contained therein.

11. The apparatus according to claim 6, wherein the video-based dynamic mesh coding parameter set has a syntax structure stored in a network abstraction layer unit in an atlas bitstream.

12. The apparatus according to claim 6, wherein the video-based dynamic mesh coding parameter set has a syntax structure stored in a in common atlas parameter set syntax structure as an extension.

13. The apparatus according to claim 2, wherein a specific network abstraction layer unit type is defined in an atlas bitstream, of the multi-format bitstream, for one or more auxiliary bitstreams comprising one or both of a base mesh bitstream or arithmetically coded displacement bitstream.

14. The apparatus according to claim 2, wherein the merging comprises consecutively placing data from two or more formats that contain exactly one coded content representation when merged into the multi-format bitstream.

15. The apparatus according to claim 2, wherein signal information that indicates data of the first format and the second format in a multi-format bitstream is placed in one or more supplemental enhancement information messages according to the first format.

16. The apparatus according to claim 2, wherein the first signaling maps data unit types of the second format to data unit types of the first format.

17. The apparatus according to claim 2, wherein the merging comprises pruning the multi-format bitstream based on data unit headers of one of the first and second formats to be able to start transmitting other headers from an other of the first and second formats.

18. The apparatus according to claim 2, wherein the merging comprises interleaving data unit types of the first and second formats in the multi-format bitstream based on their joint usage in time.

19. An apparatus, comprising:
one or more processors; and
one or more memories storing instructions that, when executed by the one or more processors, cause the apparatus at least to perform:
receiving, by a decoder, a multi-format bitstream;
receiving, in the multi-format bitstream, first signaling indicating there are data of a first format and of a second format in the multi-format bitstream;
receiving, in the multi-format bitstream, second signaling to indicate mapping of network abstraction layer units between the first format and the second format in the multi-format bitstream;
separating, from the multi-format bitstream using the first signaling and the second signaling, data having the first format and related data having the second format; and
decoding the data having the first format and the related data having the second format.

20. The apparatus according to claim 19, further comprising outputting the decoded data for presentation to a user.
